(19) United States
(12) Patent Application Publication
(10) Pub. No.: US 2012/0258622 A1
(43) Pub. Date: Oct. 11, 2012

(54) RADIAL CLAMP

(75) Inventors: LAWRENCE SE-JUN OH, HUMMELSTOWN, PA (US); NICHOLAS JOSEPH GARIBALDI, MONROE TOWNSHIP, NJ (US)

(73) Assignee: TYCO ELECTRONICS CORPORATION, BERWYN, PA (US)

(21) Appl. No.: 13/080,477

(22) Filed: Apr. 5, 2011

(51) Int. Cl. H01R 9/05; F16B 2/06

(52) U.S. Cl. 439/585; 248/316.1

(57) ABSTRACT

A radial clamp has a split ring clamp body with a first end and a second end opposing one another. Fingers extend from the first and second ends. The fingers have outer surfaces that follow a curvature of the clamp body. The fingers have tool engagement surfaces configured to be engaged and actuated by a tool. The clamp body is enlarged when the tool engagement surfaces are actuated by the tool.

### BACKGROUND OF THE INVENTION

The subject matter herein relates generally to electrical connectors, and more particularly to cable mounted electrical connectors.

Electrical connectors used to plug a communication cable into an electrical system may include a shell that provides shielding for one or more contacts housed within the shell. The shell is terminated to a shield, such as a cable braid, of the cable that provides shielding for wire(s) in the cable. However, pluggable connectors that are currently used may have certain limitations due to unwanted electromagnetic interference, which harms signal integrity and the performance of the connector. The shielding around the contacts is an important factor in controlling unwanted electromagnetic coupling. The connection between the shell and the shield of the cable is a source of problems with the shielding of the contact and wires. Also, strain relief between the cable and the electrical connector is another problem.

There are known methods of terminating the shield to the shell, however such known methods are not without disadvantages in terms of cost, complexity, relaxing over time, repair/reuse and the like. One known method uses mini-bands that are applied over the shield using an application tool that cinches the band onto the shield. However, the tool used to apply the mini-bands is expensive. Additionally, the mini-bands tend to relax over time making the mini-band ineffective. Furthermore, removal of the mini-bands requires the mini-bands to be cut off, which destroys the mini-band and may cause damage to the cable braid and/or the connector.

Another known method of securing the shield to the shell uses a coil spring band that is wrapped around the shield. The coil spring band may require many wraps to provide the mechanical strength to hold the shield in place, which may make the coil spring band thick. The coil spring also adds to the weight of the connector and the bulk of the connector. Yet another known method of securing the shield to the shell uses a Tinel lock. The Tinel lock uses inductive heating to shrink the ring, and some applications do not allow the tools required for inductive heating the Tinel lock. For example, in aerospace applications, such tools are discouraged due to the flammable substances around aircrafts and equipment, such as fuel, oil, hydraulic fluids and the like. Additionally, removal of the Tinel lock requires the lock to be cut off, which destroys the lock and may cause damage to the cable braid and/or the connector.

Accordingly, there is a need for termination methods and means for securing a shield of a cable to a conductive shell of an electrical connector in a cost effective and reliable manner. There is a need for termination methods and means for securing a shield of a cable to a conductive shell of an electrical connector that is reusable and does not damage the shield. There is a need for termination methods and means for securing a shield of a cable to a conductive shell of an electrical connector that provides a uniform termination force over the life of the product.

### BRIEF DESCRIPTION OF THE INVENTION

In one embodiment, a radial clamp is provided having a split ring clamp body with a first end and a second end opposing one another. Fingers extend from the first and second ends. The fingers have outer surfaces that follow a curvature of the clamp body. The fingers have tool engagement surfaces configured to be engaged and actuated by a tool. The clamp body is enlarged when the tool engagement surfaces are actuated by the tool.

In another embodiment, an electrical connector is provided having a conductive shell that has a mating end and a cable end. The cable end is configured to be terminated to a shield of a cable. A dielectric housing is held within the conductive shell. A contact is held by the dielectric housing. The contact is configured to be terminated to an end of a wire of the cable. A radial clamp is configured to mechanically press the shield to the cable end of the conductive shell. The radial clamp has a split ring clamp body that has a first end and a second end opposing one another and fingers that extend from the first and second ends. The fingers have outer surfaces that follow a curvature of the clamp body. The fingers have tool engagement surfaces configured to be engaged and actuated by a tool. The clamp body is enlarged when the tool engagement surfaces are actuated by the tool. The clamp body imparts a normal force on the shield to press the shield into the conductive shell.

In a further embodiment, an electrical connector is provided having a cable with a wire therein and a shield providing electrical shielding around the wire. The electrical connector also has a conductive shell having a mating end and a cable end. The cable end is terminated to the shield of the cable. A dielectric housing is held within the conductive shell. A contact is held by the dielectric housing. The contact is terminated to an end of the wire of the cable. A radial clamp mechanically presses the shield to the cable end of the conductive shell. The radial clamp includes a split ring clamp body that has a first end and a second end opposing one another and fingers that extend from the first and second ends. The fingers have outer surfaces that follow a curvature of the clamp body. The fingers have tool engagement surfaces configured to be engaged and actuated by a tool. The clamp body is enlarged when the tool engagement surfaces are actuated by the tool. The clamp body imparts a normal force on the shield to press the shield into the conductive shell.

### BRIEF DESCRIPTION OF THE DRAWINGS

FIG. 1 is a perspective view of a connector system formed in accordance to one embodiment.

FIG. 2 is a cross-sectional view of the connector system shown in FIG. 1.

FIG. 3 is a perspective view of a radial clamp for use with an electrical connector of the connector system.

FIG. 4 is a perspective view of an alternative radial clamp formed in accordance with an alterative embodiment.

FIG. 5 is a perspective view of an alternative radial clamp formed in accordance with an alterative embodiment.

FIG. 6 is a perspective view of an alternative radial clamp formed in accordance with an alterative embodiment.

### DETAILED DESCRIPTION OF THE INVENTION

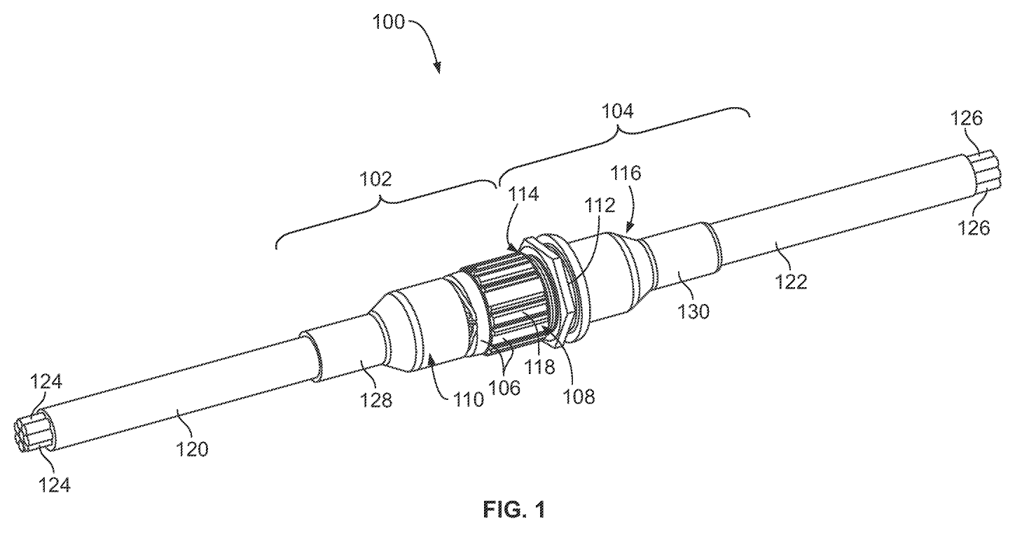

FIG. 1 is a perspective view of a connector system 100 according to one embodiment. The connector system 100 includes a female electrical connector 102 and a male electrical connector 104. In the illustrated embodiment, the female and male electrical connectors 102, 104 are shielded RF connectors, however other types of connectors may be used in alternative embodiments. The electrical connectors may be high data rate connectors. The female and male electrical connectors 102, 104 may be adapted for use in military applications, aerospace applications, automotive applications, industrial applications, commercial applications and the like.

The female electrical connector 102 includes a conductive shell 106 extending between a mating end 108 and a cable end 110. The male electrical connector 104 includes a conductive shell 112 extending between a mating end 114 and a cable end 116. The mating ends 108, 114 are connected together and secured together using a lock 118. In the illustrated embodiment, the lock 118 is a threaded collar, however other types of locks may be used in alternative embodiments, such as latches, fasteners and the like.

The female electrical connector 102 is terminated to an end of a cable 120 and the male electrical connector 104 is terminated an end of a cable 122. The cables 120, 122 each include a plurality of wires 124, 126. Any number of wires 124, 126 may be provided. Optionally, the wires 124, 126 may be arranged as twisted wire pairs, where the wires carry differential signals. The wires 124, 126 may be part of a quad cable having multiple wires. A boot 128 is provided over the cable end 110 of the female electrical connector 102 to secure the cable 120 to the shell 106. The boot 128 provides strain relief between the cable 120 and the shell 106. A boot 130 is provided over the cable end 116 of the male electrical connector 104 to secure the cable 122 to the shell 112. The boot 130 provides strain relief between the cable 122 and the shell 112.

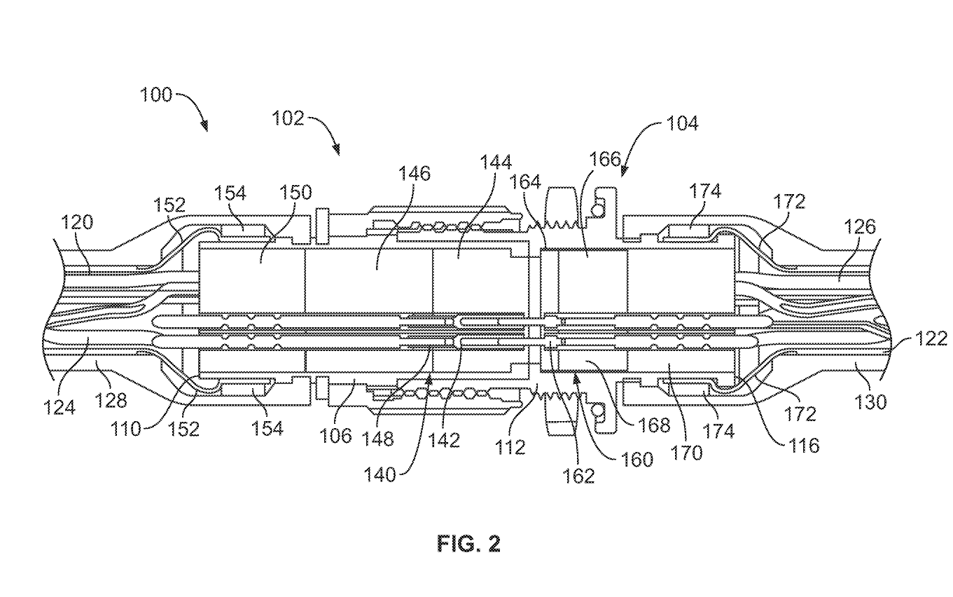

FIG. 2 is a cross-sectional view of the connector system 100 showing the female electrical connector 102 coupled to the male electrical connector 104. The female electrical connector 102 includes a dielectric housing 140 received in the shell 106. The dielectric housing 140 holds a plurality of contacts 142 therein. In the illustrated embodiment, the dielectric housing 140 is a two part housing having a front housing 144 and a rear housing 146. The contacts 142 are secured within the dielectric housing 140 using a retention clip 148 that is positioned between the front and rear housing 144, 146. The contacts 142 are terminated to ends of the wires 124, such as by a crimp connection. The wires 124 extend through a seal 150 provided rearward of the dielectric housing 140. The seal 150 is held within the shell 106.

The cable 120 includes a shield 152 circumferentially surrounding the wires 124. The shield 152 provides electrical shielding for the wires 124 along the length of the cable 120. In an exemplary embodiment, the shield 152 is a cable braid. The shield 152 is terminated to the shell 106 using a radial clamp 154. The radial clamp 154 surrounds the shield 152 and the cable end 110 of the shell 106. The radial clamp 154 imparts a normal force on the shield 152 for mechanical retention of the shield 152 to the shell 106. The radial clamp 154 ensures electrical connectivity between the shield 152 and the shell 106. The radial clamp 154 squeezes against the shield 152 to ensure that the shield 152 maintains electrical contact with the shell 106. The radial clamp 154 extends circumferentially around the shield 152 and provides a constant normal force for 360° around the shield 152.

The radial clamp 154 has a low profile such that the boot 128 is capable of being applied over the radial clamp 154. The boot 128 may be applied over the radial clamp 154, the shield 152 and the shell 106 at the cable end 110 of the shell 106 by heat shrinking the boot 128 over the shield termination. In an exemplary embodiment, the shell 106 includes a recess or groove defined between a pair of lips or flanges at the cable end 110 of the shell 106. The radial clamp 154 and shield 152 are received in the groove and positioned between the flanges. Alternatively, only a rearward flange is provided behind the position of the radial clamp 154. The rearward flange provides a surface that blocks the radial clamp 154 and/or shield 152 from being pulled off the shell 106. The flange anchors the radial clamp 154 and/or shield 152 to the shell 106 and resists rearward sliding of the radial clamp 154 and/or shield 152. The engagement between the radial clamp 154 and/or shield 152 and the rearward flange acts as a strain relief feature for the cable. Optionally, the edge surfaces of the rearward flange and the radial clamp 154 that abut against one another may be counter angled to better retain the shield 152 between the radial clamp 154 and the flange (e.g. by forcing the shield 152 to bend greater than 90° in transitioning out of the recess.

The male electrical connector 104 includes a dielectric housing 160 received in the shell 112. The dielectric housing 160 holds a plurality of contacts 162 therein. In the illustrated embodiment, the dielectric housing 160 is a two part housing having a front housing 164 and a rear housing 166. The contacts 162 are secured within the dielectric housing 160 using a retention clip 168 that is positioned between the front and rear housing 164, 166. The contacts 162 are terminated to ends of the wires 126, such as by a crimp connection. The wires 126 extend through a seal 170 provided rearward of the dielectric housing 160. The seal 170 is held within the shell 112.

The cable 122 includes a shield 172 circumferentially surrounding the wires 126. The shield 172 provides electrical shielding for the wires 126 along the length of the cable 122. In an exemplary embodiment, the shield 172 is a cable braid. The shield 172 is terminated to the shell 112 using a radial clamp 174. The radial clamp 174 surrounds the shield 172 and the cable end 116 of the shell 112. The radial clamp 174 may be substantially similar to the radial clamp 154. The boot 130 may be applied over the radial clamp 174, the shield 172 and the shell 112 at the cable end 116 of the shell 112 by heat shrinking the boot 130 over the shield termination.

In an exemplary embodiment, the shell 112 includes a recess or groove defined between a pair of lips or flanges at the cable end 116 of the shell 112. The radial clamp 174 and shield 172 are received in the groove and positioned between the flanges. Alternatively, only a rearward flange is provided behind the position of the radial clamp 174. The rearward flange provides a surface that blocks the radial clamp 174 and/or shield 172 from being pulled off the shell 112. The flange anchors the radial clamp 174 and/or shield 172 to the shell 112 and resists rearward sliding of the radial clamp 174 and/or shield 172. The engagement between the radial clamp 174 and/or shield 172 and the rearward flange acts as a strain relief feature for the cable. Optionally, the edge surfaces of the rearward flange and the radial clamp 174 that abut against one another may be counter angled to better retain the shield 172 between the radial clamp 174 and the flange (e.g. by forcing the shield 172 to bend greater than 90° in transitioning out of the recess.

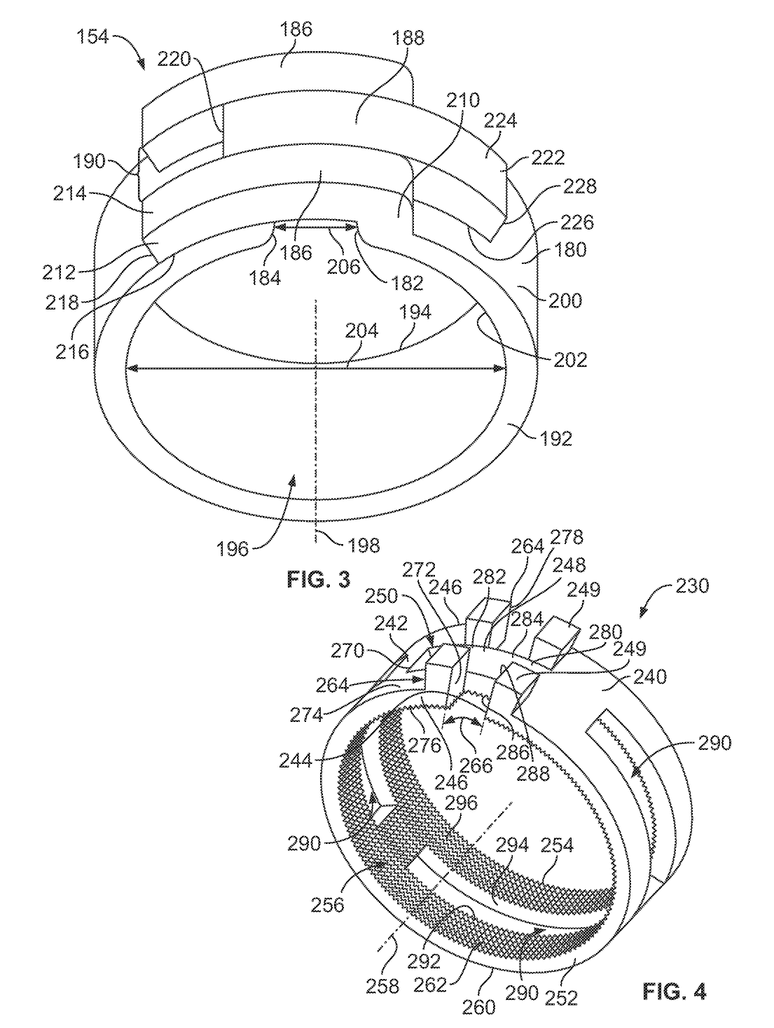

FIG. 3 is a perspective view of the radial clamp 154. The radial clamp 154 includes a clamp body 180 extending between a first end 182 and a second end 184. The clamp body 180 is of a split ring design where the first and second ends 182, 184 oppose one another and are movable with respect to one another to change a size of the clamp body 180. One or more fingers 186 extend from the first end 182 and one or more fingers 188 extend from the second end 184. In the illustrated embodiment, a pair of fingers 186 extends from the first end 182 and single finger 188 extends from the second end 184, which is received between the pair of fingers 186. The pair of fingers 186 defines a track 190 therebetween where the finger 188 is received within the track 190 and guided by the track 190. The fingers 186, 188 are configured to engage one another to guide relative movement therebetween. Other configurations of the fingers 186, 188 are possible in alternative embodiments, including a single finger 186 and a single finger 188.

The clamp body 180 has a first side 192 and a second side 194 opposite the first side 192. The clamp body 180 has an opening 196 extending along a clamp axis 198 between the first and second sides 192, 194. The clamp body 180 has an outer surface 200 and an inner surface 202 that defines the opening 196. The clamp body 180 is generally circular in shape surrounding the clamp axis 198.

The clamp body 180 is manufactured from a resilient material, such as a metal material that is configured to be elastically deformed and then, upon unloading, return to its original shape. The clamp body 180 has an inner diameter 204. During use, the clamp body 180 may be enlarged by spreading the first end 182 and second end 184 apart from one another, increasing the diameter 204. For example, the clamp body 180 may be spread apart to position the radial clamp 154 in position over the shield 152 (shown in FIG. 2) and the shell 106 (shown in FIG. 2). In an exemplary embodiment, the clamp body 180 is opened by squeezing the fingers 186, 188 to spread the first end 182 apart from the second end 184 to create or enlarge a gap 206 therebetween. Once positioned, the clamp body 180 is allowed to return to the normal position by closing the gap 206 between the first and second ends 182, 184.

As the clamp body 180 closes, the clamp body 180 presses the shield 152 against the shell 106. The shell 106 may have a diameter that is larger than the diameter 204 of the clamp body 180 when the clamp body 180 is in the normal or relaxed state. As such, the clamp body 180 may not fully close when released, but rather may remain partially open, which allows the radial clamp 154 to impart a constant normal force on the shield 152. The radial clamp 154 applies constant pressure to the shield 152 because the clamp body 180 remains in a partially elastically deformed state when the radial clamp 154 is positioned over the shield 152 and the shell 106. The radial clamp 154 provides strain relief for the cable by holding the shield 152. Optionally, the clamp body 180 may be opened to accommodate a plurality of different sized shells 106 that have a range of sizes or diameters.

Each finger 186 extends between a fixed end 210 and a free end 212. The finger 186 has an outer surface 214 and an inner surface 216 that is positioned radially inward of the outer surface 214. The fixed end 210 is attached to the first end 182. Optionally, the fixed end 210 extends from the outer surface 200 such that the finger 186 is positioned radially outward of the outer surface 200. The finger 186 generally follows a curvature of the clamp body 180 such that the inner surface 216 rests on, and is coincident with, the outer surface 200 of the clamp body 180. The finger 186 is curved to match the curvature of the clamp body 180. The finger 186 has a tool engagement surface 218 at the free end 212. The tool engagement surface 218 is configured to be engaged by and actuated by a tool to squeeze the clamp body 180 open. The tool may be a simple, readily available tool, such as pliers.

The finger 188 extends between a fixed end 220 and a free end 222. The finger 188 has an outer surface 224 and an inner surface 226 that is positioned radially inward of the outer surface 224. The fixed end 220 is attached to the second end 184. Optionally, the fixed end 220 extends from the outer surface 200 such that the finger 188 is positioned radially outward of the outer surface 200. The finger 188 generally follows a curvature of the clamp body 180 such that the inner surface 226 rests on, and is coincident with, the outer surface 200 of the clamp body 180. The finger 188 is curved to match the curvature of the clamp body 180. The finger 188 has a tool engagement surface 228 at the free end 222. The tool engagement surface 228 is configured to be engaged by and actuated by a tool to squeeze the clamp body 180 open.

During use, the tool is used to squeeze open the clamp body 180. For example, the tool is positioned to engage the tool engagement surface 218 and the tool engagement surface 228 of the fingers 186, 188, respectively. The tool is actuated to press the tool against the tool engagement surfaces 218, 228. As the tool is actuated, the fingers 186, 188 slide relative to one another to open the gap 206. The finger 188 is guided by the fingers 186 within the track 190 to control the path of movement of the fingers 186, 188 and thus the first and second ends 182, 184.

The outer surfaces 214, 224 of the fingers 186, 188 have a matched contour to that of the outer surface 200 of the clamp body 180. The outer surfaces 214, 224 are positioned radially outward of the outer surface 200 by a small amount such that the radial clamp 154 has a low profile. The fingers 186 are arranged such that the free ends 212 are positioned radially outward of, and slide along, the second end 184 of the clamp body 180. Similarly, the free end 222 of the finger 188 is positioned radially outward of, and slides along, the first end 182 of the clamp body 180. The fingers 186, 188 may be actuated by the tool until the tool engages the fixed ends 210, 220 of the fingers 186, 188. The fixed ends 210, 220 define a stop for the tool. As such, the range of motion of the fingers 186, 188 is limited so as not to damage the radial clamp 154.

FIG. 4 is a perspective view of an alternative radial clamp 230 formed in accordance with an alterative embodiment. The radial clamp 230 is similar to the radial clamp 154 (shown in FIG. 3) and may be used in place of the radial clamp 154. The radial clamp 230 differs from the radial clamp 154 in that the radial clamp 230 includes a different configuration of fingers and tool engagement surfaces. The radial clamp 230 also includes features to increase a grip factor with the shield 152 (shown in FIG. 2).

The radial clamp 230 includes a clamp body 240 extending between a first end 242 and a second end 244. The clamp body 240 is of a split ring design where the first and second ends 242, 244 oppose one another and are movable with respect to one another to change a size of the clamp body 240. One or more fingers 246 extend from the first end 242 and one or more fingers 248, 249 extend from the second end 244. In the illustrated embodiment, a pair of fingers 246 extends from the first end 242 and three fingers 248, 249 extend from the second end 244, with a single circumferential finger 248 extending along the circumference of the clamp body 240 and with two radial fingers 249 extending radially outward from the clamp body 240. The pair of fingers 246 defines a track 250 therebetween where the circumferential finger 248 is received within the track 250 and guided by the track 250. The fingers 246, 248 are configured to engage one another to guide relative movement therebetween.

The clamp body 240 has a first side 252 and a second side 254 opposite the first side 252. The clamp body 240 has an opening 256 extending along a clamp axis 258 between the first and second sides 252, 254. The clamp body 240 has an outer surface 260 and an inner surface 262 that defines the opening 256. The clamp body 240 is generally circular in shape surrounding the clamp axis 258.

The fingers 246 have radial segments 264 extending radially outward from distal ends of the fingers 246. The radial segments 264 oppose the radial fingers 249. The radial segments 264 and the radial fingers 249 are positioned radially outward of the outer surface 260 by a small amount such that the radial clamp 230 has a low profile. In an exemplary embodiment, the clamp body 240 is opened by prying the fingers 246, 249 apart to spread the first end 242 apart from the second end 244 to create or enlarge a gap 266 therebetween.

Each finger 246 extends between a fixed end 270 and a free end 272. The finger 246 has an outer surface 274 and an inner surface 276 that are circumferentially aligned with the outer and inner surfaces 260, 262 of the clamp body 240. The radial segments 264 extend radially outward from the outer surfaces 260 at the free end 272. The fixed end 270 extends from the first end 242. The finger 246 generally follows a curvature of the clamp body 240. The finger 246 is curved to match the curvature of the clamp body 240. The radial segments 264 of the fingers 246 have tool engagement surfaces 278. The tool engagement surfaces 278 are configured to be engaged by and actuated by a tool to pry the clamp body 240 open.

The finger 248 extends between a fixed end 280 and a free end 282. The finger 248 has an outer surface 284 and an inner surface 286 that are circumferentially aligned with the outer and inner surfaces 260, 262 of the clamp body 240. The fixed end 280 extends from the second end 244. The finger 248 generally follows a curvature of the clamp body 240. The finger 248 is curved to match the curvature of the clamp body 240.

The radial fingers 249 have tool engagement surfaces 288. The tool engagement surfaces 288 are configured to be engaged by and actuated by a tool to pry the clamp body 240 open. As the tool is actuated, the fingers 246, 248 slide relative to one another to open the gap 266. The finger 248 is guided by the fingers 246 within the track 250 to control the path of movement of the fingers 246, 248 and thus the first and second ends 242, 244.

The clamp body 240 includes one or more slots 290 extending therethrough. The slots 290 extend at least partially circumferentially around the opening 256. The slots 290 are spaced apart from the first and second sides 252, 254. The slots 290 are defined by ledges 292, 294 on opposite sides of the slots 290. The ledges 292, 294 extend generally radially outward from the opening 256. The ledges 292, 294 may be perpendicular to the clamp axis 258. The ledges 292, 294 may be generally parallel to the first and second sides 252, 254. When the radial clamp 230 is positioned on and engaging the shield 152, at least a portion of the shield 152 may be at least partially extruded into the slots 290. The ledges 292, 294 define shoulders or surfaces that engage the shield 152 to provide additional grip for holding the relative position of the radial clamp 230 and the shield 152.

The clamp body 240 has a knurled surface 296 along the inner surface 262 of the clamp body 240. The knurled surface 296 engages the shield 152. The knurled surface 296 provides additional grip for holding the relative position of the radial clamp 230 and the shield 152.

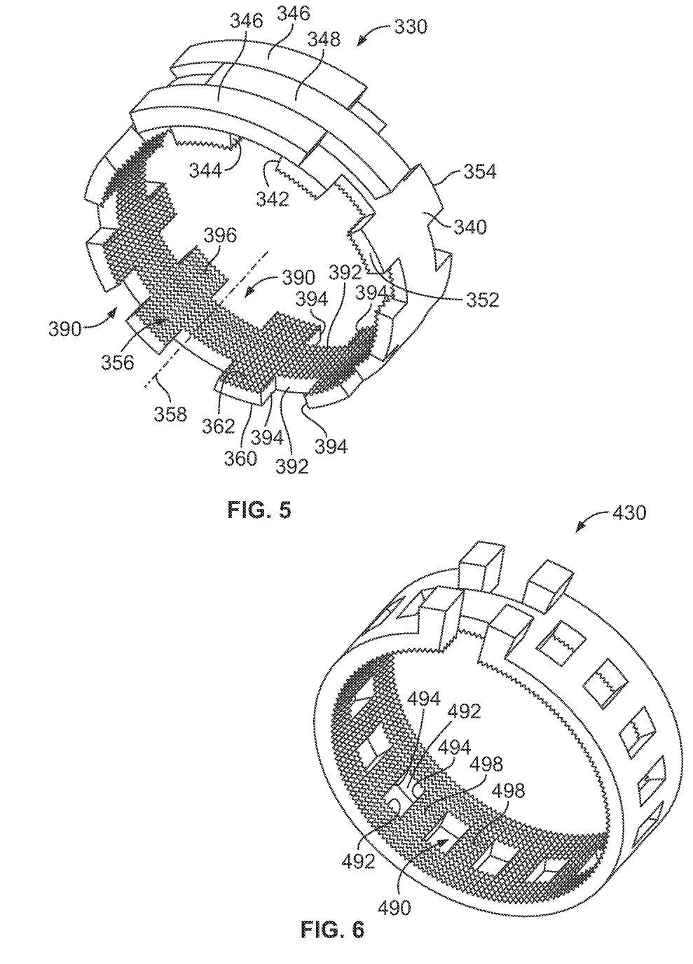

FIG. 5 is a perspective view of an alternative radial clamp 330 formed in accordance with an alterative embodiment. The radial clamp 330 is similar to the radial clamp 154 (shown in FIG. 3) and may be used in place of the radial clamp 154. The radial clamp 330 differs from the radial clamp 154 in that the radial clamp 330 includes features to increase a grip factor with the shield 152 (shown in FIG. 3).

The radial clamp 330 includes a clamp body 340 extending between a first end 342 and a second end 344. The clamp body 340 is of a split ring design where the first and second ends 342, 344 oppose one another and are movable with respect to one another to change a size of the clamp body 340. One or more fingers 346 extend from the first end 342 and one or more fingers 348 extend from the second end 344.

The clamp body 340 has a first side 352 and a second side 354 opposite the first side 352. The clamp body 340 has an opening 356 extending along a clamp axis 358 between the first and second sides 352, 354. The clamp body 340 has an outer surface 360 and an inner surface 362 that defines the opening 356. The clamp body 340 is generally circular in shape surrounding the clamp axis 358.

The clamp body 340 includes a plurality of slots 390 extending therethrough. The slots 390 extend at least partially circumferentially around the opening 356. The slots 390 are open along the first and second sides 352, 354. The slots 390 are defined by circumferential ledges 392 and axial ledges 394. The ledges 392, 394 extend generally radially outward from the opening 356. When the radial clamp 330 is positioned on and engaging the shield 152, at least a portion of the shield 152 may be at least partially extruded into the slots 390. The ledges 392, 394 define shoulders or surfaces that engage the shield 152 to provide additional grip for holding the relative position of the radial clamp 330 and the shield 152.

The clamp body 340 has a knurled surface 396 along the inner surface 362 of the clamp body 340. The knurled surface 396 engages the shield 152. The knurled surface 396 provides additional grip for holding the relative position of the radial clamp 330 and the shield 152.

FIG. 6 is a perspective view of an alternative radial clamp 430 formed in accordance with an alterative embodiment. The radial clamp 430 is similar to the radial clamp 230 (shown in FIG. 4) and may be used in place of the radial clamp 230. The radial clamp 430 differs from the radial clamp 230 in that the radial clamp 430 includes a different arrangement of slots 490 than the slots 290 (shown in FIG. 4).

The slots 490 are defined by circumferential ledges 392 and axial ledges 394. The radial clamp 430 includes many slots 490, increasing the surface area of ledges 492, 494 as compared to the slots 290. Additionally, by having many axial segments 498, the mechanical strength and/or clamping force of the radial clamp 430 may be higher than the design of the radial clamp 230 for a given material/thickness of material.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

1. A radial clamp comprising:
a split ring clamp body having a first end and a second end opposing one another, the clamp body having an outer surface being generally curved at the first and second ends and following a general radius of curvature; and
fingers extending from the first and second ends, the fingers having inner surfaces resting on the outer surface of the clamp body, the fingers being generally curved and having a radius of curvature that follows the radius of and following a curvature of the clamp body at the first and second ends, the fingers having tool engagement surfaces configured to be engaged and actuated by a tool;
wherein the clamp body is enlarged when the tool engagement surfaces are actuated by the tool.

2. The radial clamp of claim I, wherein the fingers engage one another to guide relative movement therebetween.

3. The radial clamp of claim I, wherein the first end includes a pair of fingers with a track therebetween, the track being located radially outward of the clamp body, the second end includes a single finger received within the track and guided by the track.

4. The radial clamp of claim 1, wherein the fingers have outer surfaces with a radial thickness of the fingers being defined between the inner and outer surfaces, the radial thickness of the fingers being substantially equal to a radial thickness of the clamp body such that the fingers have a low profile from the clamp body.

5. The radial clamp of claim 1, wherein the finger extending from the first end is positioned radially outward of, and slides along, the second end of the clamp body such that the second end is at least partially covered by the finger extending from the first end, and wherein the finger extending from the second end is positioned radially outward of, and slides along, the first end of the clamp body such that the first end is at least partially covered by the finger extending from the second end.

6. The radial clamp of claim 1, wherein the clamp body has a first side and a second side with an opening extending along a clamp axis between the first and second sides, the clamp body having at least one slot extending at least partially circumferentially around the opening.

7. The radial clamp of claim 1, wherein the clamp body has a first side and a second side with an opening extending along a clamp axis between the first and second sides, the clamp body having at least one ledge extending generally radially outward from the opening.

8. The radial clamp of claim 1, wherein the clamp body has an opening extending along a clamp axis, the opening being defined by an inner surface of the clamp body, the inner surface having a knurled surface.

9. An electrical connector comprising:
a conductive shell having a mating end and a cable end, the cable end being configured to be terminated to a shield of a cable;
a dielectric housing held within the conductive shell;
a contact held by the dielectric housing, the contact being configured to be terminated to an end of a wire of the cable; and
a radial clamp configured to mechanically press the shield to the cable end of the conductive shell, the radial clamp comprising a split ring clamp body having a first end and a second end opposing one another, the clamp body having an outer surface being generally curved at the first and second ends and following a general radius of curvature, the radial clamp comprising fingers extending from the first and second ends, the fingers having inner surfaces resting on the outer surface of the clamp body, the fingers being generally curved and having a radius of curvature that follows the radius of curvature of the clamp body at the first and second ends, the fingers having tool engagement surfaces configured to be engaged and actuated by a tool, wherein the clamp body is enlarged when the tool engagement surfaces are actuated by the tool and wherein the clamp body imparts a normal force on the shield to press the shield into the conductive shell.

10. The electrical connector of claim 9, wherein the fingers engage one another to guide relative movement therebetween.

11. The electrical connector of claim 9, wherein the first end includes a pair of fingers with a track therebetween, the track being located radially outward of the clamp body, the second end includes a single finger received within the track and guided by the track.

12. The electrical connector of claim 9, wherein the fingers have outer surfaces with a radial thickness of the fingers being defined between the inner and outer surfaces, the radial thickness of the fingers being substantially equal to a radial thickness of the clamp body such that the fingers have a low profile from the clamp body.

13. The electrical connector of claim 9, wherein the finger extending from the first end is positioned radially outward of, and slides along, the second end of the clamp body such that the second end is at least partially covered by the finger extending from the first end, and wherein the finger extending from the second end is positioned radially outward of and slides along, the first end of the clamp body such that the first end is at least partially covered by the finger extending from the second end.

14. The electrical connector of claim 9, wherein the clamp body has a first side and a second side with an opening extending along a clamp axis between the first and second sides, the clamp body having at least one slot extending at least partially circumferentially around the opening.

15. The electrical connector of claim 9, wherein the clamp body has a first side and a second side with an opening extending along a clamp axis between the first and second sides, the clamp body having at least one ledge extending inward from the opening, the ledge extending generally radially outward from the opening.

16. The electrical connector of claim 9, wherein the clamp body has an opening extending along a clamp axis, the opening being defined by an inner surface of the clamp body, the inner surface having a knurled surface.

17. An electrical connector comprising:
a cable having a wire therein and a shield providing electrical shielding around the wire;
a conductive shell having a mating end and a cable end, the cable end being terminated to the shield of the cable;
a dielectric housing held within the conductive shell;
a contact held by the dielectric housing, the contact being terminated to an end of the wire of the cable; and
a radial clamp configured to mechanically press the shield to the cable end of the conductive shell, the radial clamp comprising a split ring clamp body having a first end and a second end opposing one another, the clamp body having an outer surface being generally curved at the first and second ends and following a general radius of curvature, the radial clamp comprising fingers extending from the first and second ends, the fingers having inner surfaces resting on the outer surface of the clamp body, the fingers being generally curved and having a radius of curvature that follows the radius of curvature of the clamp body at the first and second ends, the fingers having tool engagement surfaces configured to be engaged and actuated by a tool, wherein the clamp body is enlarged when the tool engagement surfaces are actuated by the tool and wherein the clamp body imparts a normal force on the shield to press the shield into the conductive shell.

18. The electrical connector of claim 17, wherein the clamp body has a first side and a second side with an opening extending along a clamp axis between the first and second sides, the clamp body having at least one slot extending at least partially circumferentially around the opening.

19. The electrical connector of claim 17, wherein the clamp body has a first side and a second side with an opening extending along a clamp axis between the first and second sides, the clamp body having at least one ledge extending inward from the opening, the ledge extending generally radially outward from the opening.

20. The electrical connector of claim 17, wherein the clamp body has an opening extending along a clamp axis, the opening being defined by an inner surface of the clamp body, the inner surface having a knurled surface.
